(19) United States
(12) Patent Application Publication
(10) Pub. No.: US 2019/0180080 A1
(43) Pub. Date: Jun. 13, 2019

(54) CELL-STATE MEASUREMENT DEVICE

(71) Applicant: Olympus Corporation, Tokyo (JP)

(72) Inventors: Yasunobu IGA, Tokyo (JP); Hitoshi Echigo, Kanagawa (JP); Akira Matsushita, Tokyo (JP)

(73) Assignee: Olympus Corporation, Tokyo (JP)

(21) Appl. No.: 16/275,504

(22) Filed: Feb. 14, 2019

Related U.S. Application Data
(63) Continuation of application No. PCT/JP2017/034633, filed on Sep. 26, 2017.

(30) Foreign Application Priority Data
Sep. 28, 2016 (JP) PCT/JP2016/078728

(51) Int. Cl. G06K 9/00; H04N 5/225; G01N 15/14

(52) U.S. Cl. CPC G06K 9/00134; G01N 2015/1486; G01N 15/1429; H04N 5/2252

(57) ABSTRACT

A cell-state measurement device acquires an image of a culture surface in a vessel formed of an optically transparent material, measures a state of cells being cultured on the culture surface, and includes: a housing including a stage on which the vessel is placed; and an image acquisition unit accommodated in the housing and configured to acquire an image of the cells in the vessel, wherein the image acquisition unit includes: a line sensor including a plurality of light receiving elements linearly arranged; an objective lens disposed between the sensor and the stage; an illuminator illuminating a field of view of the objective lens; and a scanner moving the sensor, wherein the illuminator emits illumination light upward, and wherein the illumination light emitted by the illuminator is reflected downward by the vessel, is transmitted through the culture surface and is incident on the objective lens.

### CROSS-REFERENCE TO RELATED APPLICATIONS

This is a continuation of International Application PCT/JP2017/034633 which is hereby incorporated by reference herein in its entirety.

This application claims the benefit of International Application PCT/JP2016/078728, the content of which is incorporated herein by reference.

### TECHNICAL FIELD

The present invention relates to a cell-state measurement device.

### BACKGROUND ART

In the related art, a method for generating a tiling image of the entire bottom surface of a culture vessel is used in order to observe the distribution of cells being cultured in a culture vessel and colonies therein (for example, see PTL 1). The tiling image is generated by acquiring many images by means of a 2D image sensor while changing an image capturing position and by connecting the many images.

### CITATION LIST

### Patent Literature

### {PTL 1} Japanese Unexamined Patent Application, Publication No. 2012-173725

### SUMMARY OF INVENTION

According to one aspect, the present invention provides a cell-state measurement device that acquires an image of a culture surface in a vessel formed of an optically transparent material and that measures a state of cells that are being cultured on the culture surface, the device including: a housing that includes a stage on which the vessel is placed, the stage being formed of a horizontally disposed flat-plate-like member; and an image acquisition unit that is accommodated in the housing and that is configured to acquire an image of the cells in the vessel, wherein the image acquisition unit includes: a line sensor that includes a plurality of light receiving elements which are linearly arranged; an objective lens that is disposed between the line sensor and the stage; an illuminator that illuminates a field of view of the objective lens; and a scanner that moves the line sensor, wherein the illuminator emits illumination light upward from a lower part of the vessel, and wherein the illumination light emitted by the illuminator is reflected downward by a reflecting surface of a top plate of the vessel, is transmitted through the culture surface and is incident on the objective lens.

### BRIEF DESCRIPTION OF DRAWINGS

FIG. 1 is a block diagram showing the overall configuration of a cell-state measurement device according to one embodiment of the present invention.

FIG. 2 is a perspective view showing a housing of the cell-state measurement device shown in FIG. 1 and a vessel placed on the housing.

FIG. 3 is a longitudinal sectional view of the housing and the vessel shown in FIG. 2.

FIG. 4A is a view showing the region of a culture surface within a capturing range and a preimage that is acquired by an image acquisition unit at an image-acquisition position, when a flask is used.

FIG. 4B is a view showing the regions of culture surfaces within the capturing range and a preimage that is acquired by the image acquisition unit at the image-acquisition position, when a 6-well plate is used.

FIG. 4C is a view showing the regions of culture surfaces within the capturing range and a preimage that is acquired by the image acquisition unit at the image-acquisition position, when a 24-well plate is used.

FIG. 5 is a view showing an example 2D image acquired by the image acquisition unit of the cell-state measurement device shown in FIG. 1.

FIG. 6 is a flowchart showing the operation of the cell-state measurement device shown in FIG. 1.

FIG. 7 is a view showing other example 2D images acquired by the image acquisition unit of the cell-state measurement device shown in FIG. 1.

FIG. 8 is a perspective view showing the housing of the cell-state measurement device shown in FIG. 1 and a multiwell plate placed on the housing.

FIG. 9 is a view showing example vessel-region images acquired by the image acquisition unit when a multiwell plate is used and example identification names associated with the respective vessel-region images.

FIG. 10 is a view showing time-series images acquired by the image acquisition unit of the cell-state measurement device shown in FIG. 1.

FIG. 11 is a view showing an example graph of a temporal change in the measurement values of the states of cells measured in the time-series images shown in FIG. 10.

FIG. 12 is a view showing an example display, on a display unit, of time-series vessel-region images and a temporal change in the measurement values.

FIG. 13 is a view showing other example time-series vessel-region images acquired by the image acquisition unit of the cell-state measurement device shown in FIG. 1.

FIG. 14 is a view showing a state in which the time-series vessel-region images shown in FIG. 13 are arranged on the basis of the regions of the respective culture surfaces.

FIG. 15 is a view showing an example graph of temporal changes of the measurement values of the states of cells measured in the time-series vessel-region images shown in FIG. 13.

### DESCRIPTION OF EMBODIMENTS

A cell-state measurement device 100 according to one embodiment of the present invention will be described below with reference to the drawings.

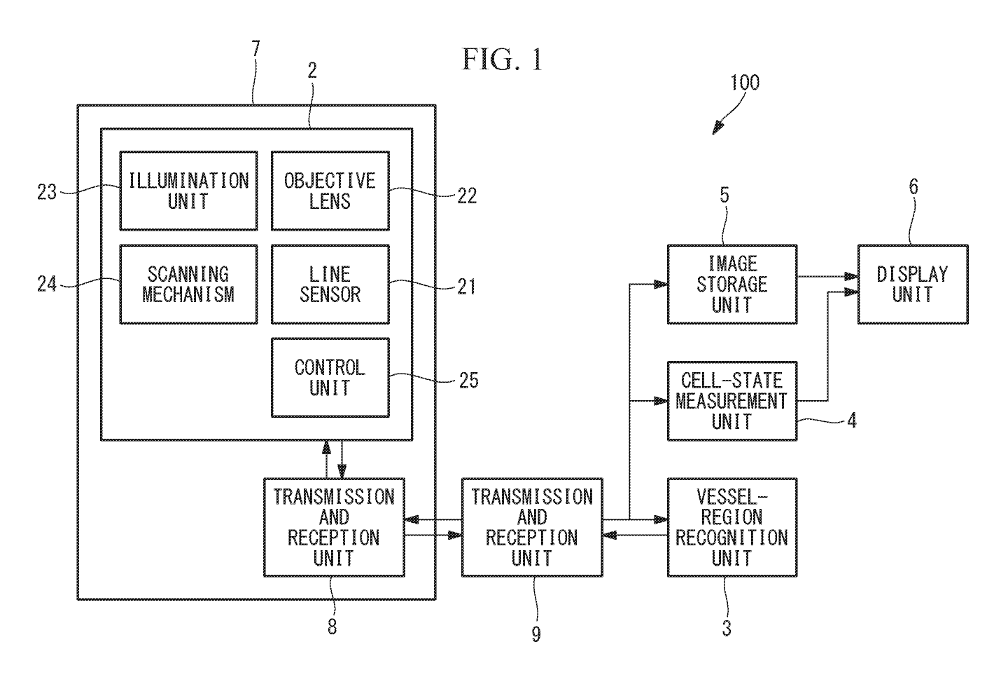

The cell-state measurement device 100 of this embodiment acquires an image of a culture surface 1a in a vessel 1 and measures the state of cells A that are being cultured on the culture surface 1a. As shown in FIG. 1, the cell-state measurement device 100 is provided with an image acquisition unit 2, a vessel-region recognition unit 3, a cell-state measurement unit 4, an image storage unit 5, and a display unit 6. The image acquisition unit 2 scans a line sensor 21 with respect to the culture surface 1a, thereby making it possible to acquire a 2D image P within a predetermined capturing range R that includes the culture surface 1a. The vessel-region recognition unit 3 recognizes a region Q of the culture surface 1a within the capturing range R. The cell-state measurement unit 4 measures the state of the cells A in the region Q in the image P. The image storage unit 5 stores the image P. The display unit 6 displays the image P together with a measurement result obtained by the cell-state measurement unit 4.

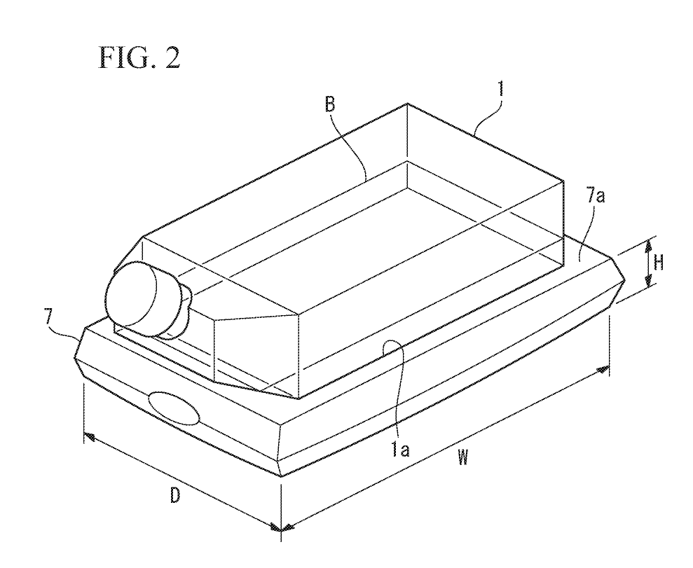

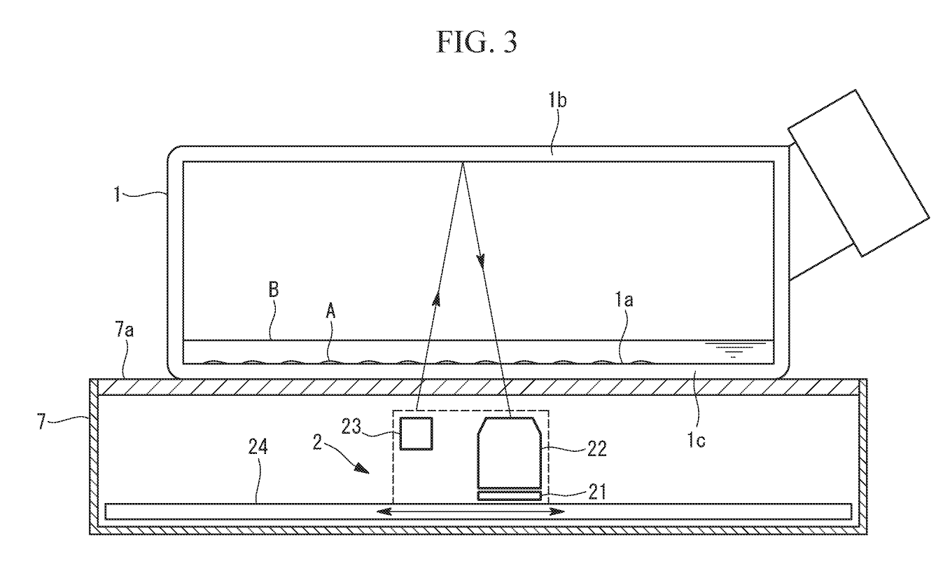

Furthermore, as shown in FIGS. 2 and 3, the cell-state measurement device 100 is provided with a housing 7 that is formed of a substantially-rectangular sealed vessel having a height H, a width W, and a depth D. The image acquisition unit 2 is accommodated in the housing 7, and the vessel-region recognition unit 3, the cell-state measurement unit 4, the image storage unit 5, and the display unit 6 are disposed outside the housing 7.

A top panel of the housing 7, the top panel being provided on one side thereof in the height direction (vertical direction in FIG. 3), is formed of a horizontally disposed flat-plate-like member and constitutes a stage 7a on which the vessel 1 is placed. The stage 7a is formed of an optically transparent material, for example, glass, so as to allow illumination light from an illumination unit 23, which will be described later, to be transmitted therethrough.

The vessel 1 is a sealed vessel that is entirely formed of an optically transparent material and that accommodates cells A and a culture medium B. In this embodiment, it is assumed that a vessel that is generally used for cell culturing (for example, a flask, dish, or a multiwell plate having 6, 12, or 24 wells) is used as the vessel 1. FIGS. 2 and 3 show a flask. The vessel 1 has a top plate 1b and a bottom plate 1c that are opposed to each other, and the top plate 1b is provided with a reflecting surface for reflecting illumination light downward. An inner surface of the bottom plate 1c serves as the culture surface 1a to which the cells A adhere.

The stage 7a is provided with a positioning means (not shown) for positioning the vessel 1, such that the vessel 1 is placed at a predetermined position on the stage 7a and in a predetermined direction. The positioning means may be, for example, a wall or a projection that is formed upright on the stage 7a and against which a side surface of the vessel 1 abuts or may be a mark, such as a line, put on the stage 7a.

The image acquisition unit 2 is provided with the straight line sensor 21, a plurality of objective lenses 22, the illumination unit 23, a scanning mechanism 24, and a control unit 25. The line sensor 21 is disposed along the depth direction of the housing 7 (direction normal to the plane of FIG. 3) substantially parallel to the stage 7a. The plurality of objective lenses 22 are disposed between the line sensor 21 and the stage 7a. The illumination unit 23 illuminates the fields of view of the plurality of objective lenses 22. The scanning mechanism 24 moves the line sensor 21. The control unit 25 controls the line sensor 21, the illumination unit 23, and the scanning mechanism 24.

The line sensor 21 has a plurality of light receiving elements arranged in the longitudinal direction, detects light incident on the plurality of light receiving elements, and acquires an image for one line at a time. It is preferred that the line sensor 21 extend over substantially the entire length of the depth of the housing 7 such that substantially the entire range of the stage 7a in the depth direction is included in the capturing range R of the line sensor 21.

The plurality of objective lenses 22 are disposed along a direction in which the optical axes thereof are perpendicular to the stage 7a and focus light transmitted through the stage 7a. The plurality of objective lenses 22 are arrayed in a line along the longitudinal direction of the line sensor 21 and form optical images in the same plane. The line sensor 21 is disposed on the image plane of the plurality of objective lenses 22, so that the optical images formed in the image plane by the plurality of objective lenses 22 are acquired by the line sensor 21. The focal points of the objective lenses 22 are adjusted by a focus adjustment mechanism (not shown) so as to be aligned with the culture surface 1a. It is also possible to use the objective lenses 22 that have a large depth of field, so as to eliminate the adjustment of the focal positions.

The illumination unit 23 is disposed side by side with the image acquisition unit 2 in the width direction of the housing 7 (horizontal direction in FIG. 3) and emits illumination light upward. The illumination light emitted by the illumination unit 23 is transmitted through the stage 7a and the bottom plate 1c of the vessel 1 and is reflected downward at the reflecting surface on the top plate 1b of the vessel 1. Accordingly, the fields of view of the plurality of objective lenses 22 are illuminated from above, and the illumination light transmitted through the cells A, the bottom plate 1c, and the stage 7a is incident on the objective lenses 22.

The scanning mechanism 24 integrally moves, by means of a linear actuator (not shown), for example, the line sensor 21, the objective lenses 22, and the illumination unit 23 in a one-dimensional manner in the scanning direction (i.e., the width direction of the housing 7) perpendicular to the longitudinal direction of the line sensor 21. It is preferred that the scanning mechanism 24 be able to move the line sensor 21, the objective lenses 22, and the illumination unit 23 over substantially the entire length of the width of the housing 7 from one end to the other end in the width direction, such that substantially the entire range of the stage 7a in the width direction is included in the capturing range R of the line sensor 21.

The control unit 25 causes the line sensor 21, the illumination unit 23, and the scanning mechanism 24 to perform acquisition of a 1D preimage and acquisition of a 2D image P in sequence.

Specifically, the control unit 25 controls the scanning mechanism 24 to dispose the line sensor 21 at a predetermined image-acquisition position in the scanning direction and next controls the line sensor 21 and the illumination unit 23 to acquire a preimage for one line at the image-acquisition position, in a state in which the line sensor 21 is immobilized.

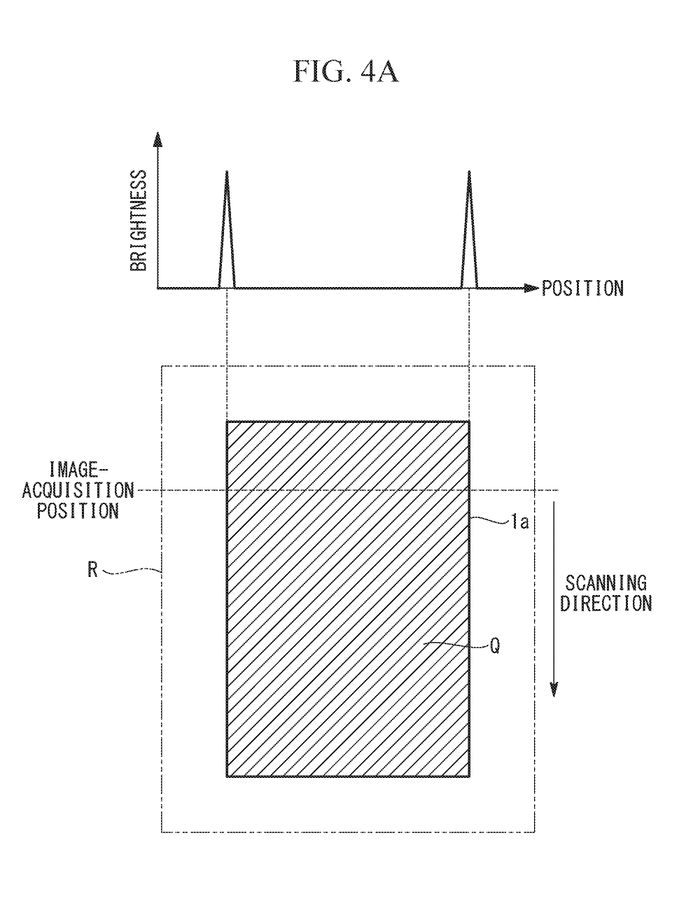

As shown in FIGS. 4A to 4C, the preimage is an image expressing a brightness change in the longitudinal direction of the line sensor 21. FIGS. 4A, 4B, and 4C respectively show preimages obtained when a flask, a 6-well plate, and a 24-well plate are used.

As shown in FIGS. 4A to 4C, brightness peaks appear in the corresponding preimage at the positions of the edges of the vessel 1 where walls exist and the edges of the culture surface 1a. Because the size of the entirety of the vessel 1 in the depth direction, the size of the culture surface 1a, the number of the culture surfaces 1a, and the arrangement of the culture surfaces 1a differ depending on the type of the vessel 1, the number of brightness peaks in the preimage and the positions thereof also differ depending on the type of the vessel 1. The image-acquisition position is set at a position where a brightness profile that differs depending on the type of the vessel 1 is obtained when the vessel 1 is disposed at the predetermined position on the stage 7a and in the predetermined direction.

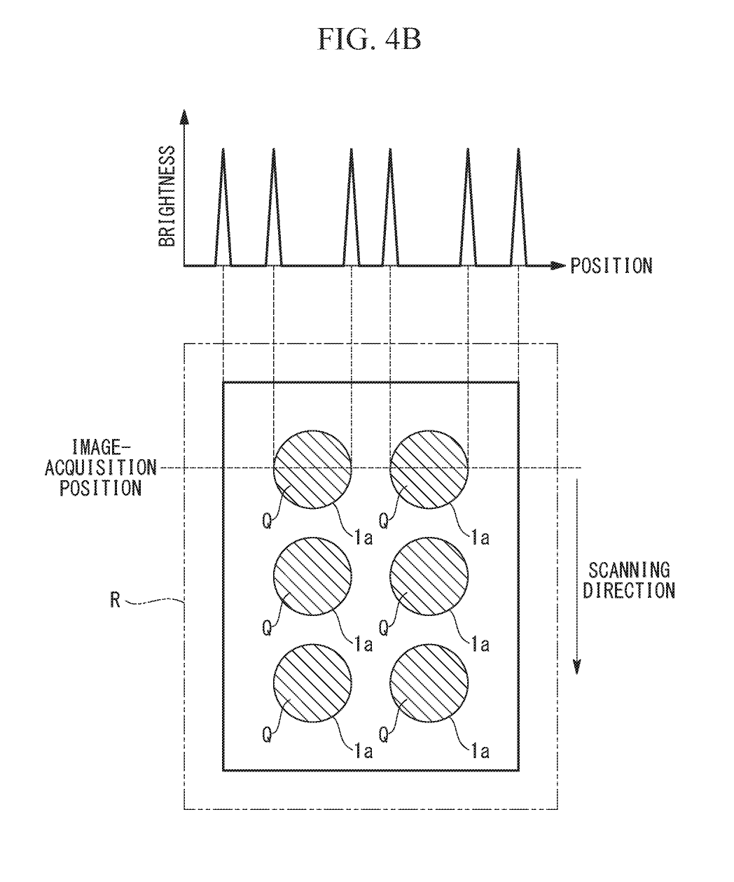

After the preimage is obtained, the control unit 25 controls the line sensor 21, the illumination unit 23, and the scanning mechanism 24 such that acquisition of an image in each line is repeated while the line sensor 21 is moved in the scanning direction. At this time, the control unit 25 controls the line sensor 21, the illumination unit 23, and the scanning mechanism 24 so as to acquire a 2D vessel-region image P that is an image of only the region Q of the culture surface 1a within the capturing range R, as shown in FIG. 5, on the basis of position information about the region Q of the culture surface 1a received from the vessel-region recognition unit 3. Therefore, only a single rectangular or circular vessel-region image P is acquired when a flask or dish is used, and the same number of the circular vessel-region images P as the culture surfaces 1a is acquired when a multiwell plate is used.

Transmission and reception units 8 and 9 are respectively provided inside and outside the housing 7. Data of a preimage is transmitted from the image acquisition unit 2 to the vessel-region recognition unit 3 via the transmission and reception units 8 and 9, and data of a vessel-region image P is transmitted from the image acquisition unit 2 to the cell-state measurement unit 4 and the image storage unit 5 via the transmission and reception units 8 and 9.

The vessel-region recognition unit 3 holds a database (vessel information) in which the type of the vessel 1, a brightness reference profile, and position information about the region of the culture surface 1a are associated with each other. The reference profile is a typical brightness profile obtained at the predetermined image-acquisition position by the image acquisition unit 2 in a state in which the vessel 1 is placed at the predetermined position on the stage 7a and in the predetermined direction. The position information about the region of the culture surface 1a is position information about the region of the culture surface 1a occupied in the capturing range R in a state in which the vessel 1 is placed at the predetermined position on the stage 7a and in the predetermined direction. In a case of the vessel 1 that has a plurality of the culture surfaces 1a, such as a multiwell plate, position information about the regions of all the culture surfaces 1a is associated with the type of the vessel 1 and is registered in the database.

Upon reception of a preimage, the vessel-region recognition unit 3 compares the brightness profile of the preimage with a plurality of reference profiles registered in the database and identifies the type of the vessel 1 corresponding to a reference profile that is the same as or is most similar to the brightness profile of the preimage. Next, the vessel-region recognition unit 3 transmits position information about the region of the culture surface 1a corresponding to the identified type of the vessel 1 to the image acquisition unit 2 via the transmission and reception units 8 and 9.

The cell-state measurement unit 4 measures the state of cells A in the region Q in the vessel-region image P. For example, cells A are extracted from the region Q by using known image processing, and the number of the cells A in the region Q is counted, thereby measuring at least one of the number of cells and the cell density, as the state of the cells A. The measurement value of the state of the cells A is transmitted to the display unit 6.

The display unit 6 reads the vessel-region image P from the image storage unit 5 and displays the vessel-region image P and the measurement value, which is measured in the region Q in the vessel-region image P, side by side, for example.

The vessel-region recognition unit 3 and the cell-state measurement unit 4 are realized by a computer disposed outside the housing 7, for example. The computer is provided with: a central processing unit (CPU); and a storage device that stores a vessel-region recognition program and a cell-state measurement program. The CPU executes the above-described processing according to the vessel-region recognition program and the cell-state measurement program, thereby realizing the respective functions of the vessel-region recognition unit 3 and the cell-state measurement unit 4.

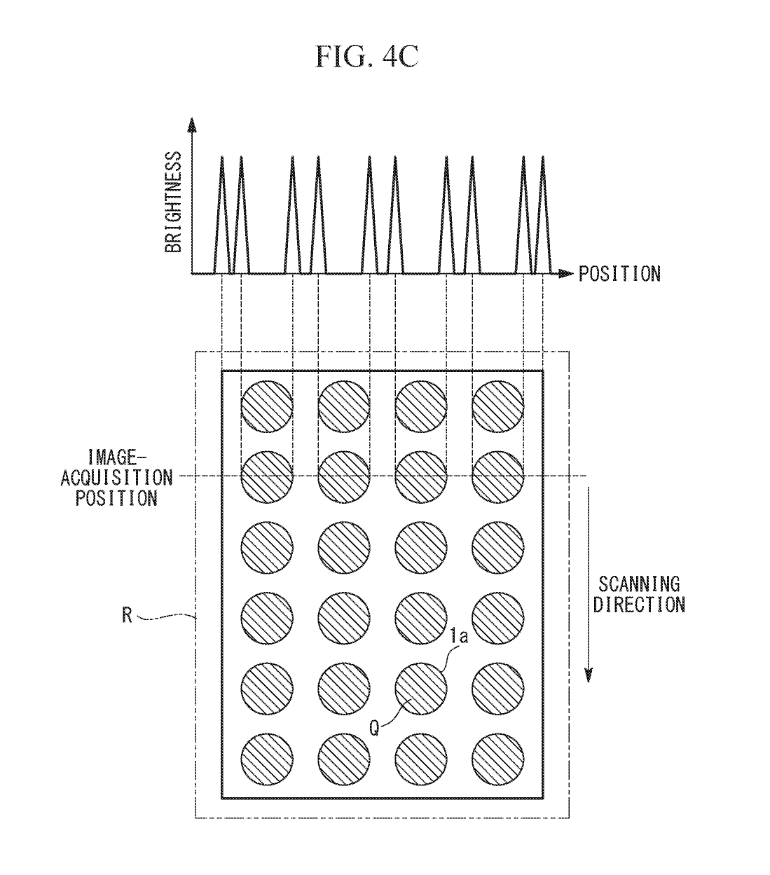

Next, the operation of the thus-configured cell-state measurement device 100 will be described with reference to FIG. 6.

The housing 7 of the cell-state measurement device 100 of this embodiment is disposed in an incubator together with the vessel 1, which is placed on the stage 7a with the bottom plate 1c facing downward. At this time, the vessel 1 is placed on the stage 7a at the predetermined position and in the predetermined direction, the predetermined position being determined by the positioning means. The image acquisition unit 2 in the housing 7 performs image capturing in the incubator according to a command signal transmitted by an operator or a program set in advance. The command signal is transmitted from an input device (not shown) outside the housing 7 to the image acquisition unit 2 via the transmission and reception units 8 and 9.

Next, the image acquisition unit 2 performs acquisition of a 1D preimage (Step S1). In the acquisition of the preimage, the line sensor 21 is disposed at the predetermined image-acquisition position by the scanning mechanism 24, and then, the illumination unit 23 and the line sensor 21 are actuated. Illumination light emitted by the illumination unit 23 is transmitted through the stage 7a and the bottom plate 1c of the vessel 1, is reflected downward at the top plate 1b, is transmitted through the cells A on the culture surface 1a, the bottom plate 1c, and the stage 7a, and is focused by the plurality of the objective lenses 22, thus being formed, in the line sensor 21, into optical images of the culture surface 1a. The line sensor 21 captures the optical images, thus acquiring a preimage for one line. The acquired preimage is transmitted to the vessel-region recognition unit 3, which is disposed outside the incubator.

Next, the vessel-region recognition unit 3 compares the brightness profile of the preimage with a plurality of reference profiles in the database, thus identifying the type of the vessel 1 in use, further recognizes the region Q of the culture surface 1a within the capturing range R of the image acquisition unit 2 on the basis of the type of the vessel 1 (Step S2), and transmits the position information about the region Q of the culture surface 1a to the image acquisition unit 2 in the incubator.

Next, the image acquisition unit 2 performs acquisition of a 2D vessel-region image P (Step S3). In acquisition of a vessel-region image P, while scanning the line sensor 21, the objective lenses 22, and the illumination unit 23 in the scanning direction with respect to the culture surface 1a through actuation of the scanning mechanism 24, the image acquisition unit 2 actuates the illumination unit 23 and the line sensor 21 on the basis of the position information about the region Q of the culture surface 1a, which is received from the vessel-region recognition unit 3, to acquire a vessel-region image P of only the region Q of the culture surface 1a. The acquired vessel-region image P is transmitted to the cell-state measurement unit 4 and the image storage unit 5, which are disposed outside the incubator, and is stored in the image storage unit 5 (Step S4).

Then, the cell-state measurement unit 4 measures the state of the cells A in the vessel-region image P, which includes only the region Q (Step S5), and the display unit 6 displays the vessel-region image P and the measurement value of the state of the cells A (for example, the number of cells or the cell density) (Step S6). Accordingly, the operator can observe, outside the incubator, the cells A, which are being cultured inside the incubator, and can grasp the state of the cells A on the basis of the measurement value.

In this case, according to this embodiment, by using the image acquisition unit 2 of the line-scan type, which acquires a 2D vessel-region image P by scanning the line sensor 21, a wide-range vessel-region image P that includes the entirety of the culture surface 1a of the vessel 1 can be acquired in a short period of time required for one cycle of scanning of the line sensor 21. Accordingly, because cells A that are distributed over a wide range are captured with a slight time difference, there is an advantage in that the state of the cells A, which change with time, can be accurately measured.

Furthermore, within the capturing range R, only the region Q of the culture surface 1a where the cells A are distributed is selectively captured by the image acquisition unit 2, and the vessel-region image P of only the region Q of the culture surface 1a is used for measurement of the state of the cells A performed by the cell-state measurement unit 4. Accordingly, there is an advantage in that, even in a case in which a region other than that of the culture surface 1a is included in the capturing range R of the image acquisition unit 2, the state of the cells A in the vessel 1 can be accurately measured by using the vessel-region image P.

Furthermore, irradiation of illumination light onto the cells A takes an extremely short period of time in order to acquire a preimage for one line. Specifically, there is an advantage in that it is possible to acquire the preimage, which is necessary to recognize the region of the culture surface 1a, while minimizing the impact on the cells A.

Furthermore, within the capturing range R, the region required by the operator is only the region Q of the culture surface 1a, and the other regions are unnecessary regions for the operator. By eliminating capturing of such unnecessary regions, there is an advantage in that the data size of the image P can be reduced.

In this embodiment, although only one preimage is acquired at one image-acquisition position, it is also possible to acquire a plurality of preimages at a plurality of image-acquisition positions located at intervals in the scanning direction. In this case, reference profiles at the respective image-acquisition positions are registered in the database of the vessel-region recognition unit 3.

By doing so, identification of the type of the vessel 1 and recognition of the region Q of the culture surface 1a can be performed with higher accuracy.

In this embodiment, although the vessel-region recognition unit 3 recognizes the region Q of the culture surface 1a on the basis of the brightness profile of the preimage, instead of this, it is also possible to recognize the region Q of the culture surface 1a on the basis of the number of brightness peaks in the preimage and/or the distance between the brightness peaks. In this case, the number of peaks and/or the distance between peaks is registered in the database, instead of the reference profile.

As described above, because peaks appear in the preimage at the edges of the vessel 1 and the edges of the culture surface 1a, the number of peaks and the distance between the peaks differ depending on the type of the vessel 1. For example, in a case of a flask, as shown in FIG. 4A, the number of peaks is two, and the distance between the peaks is large. In a case of a 6-well plate, as shown in FIG. 4B, the number of peaks is six, and the distance between adjacent peaks is small. Furthermore, because the size of the vessel 1 in the direction of the depth D differs depending on the type of the vessel 1, the distance between two outermost peaks also differs depending on the type of the vessel 1. Therefore, the type of the vessel 1 is accurately identified on the basis of the number of peaks and the distance between peaks, thereby making it possible to accurately recognize the region Q of the culture surface 1a within the capturing range R.

In this embodiment, although a preimage is acquired at the predetermined image-acquisition position, instead of this, it is also possible to acquire preimages at a plurality of arbitrary positions in the scanning direction.

Although the number of peaks is two or zero in a case of a flask and dish, the number of peaks can be six or more in a case of a multiwell plate; thus, the number of peaks differs depending on the number of wells. Furthermore, the distance between peaks is constant at any image-acquisition position in a case of a flask, whereas the distance between peaks differs depending on the image-acquisition position in a case of circular dish. Therefore, the type of the vessel 1 can be identified on the basis of the number of brightness peaks and the distance between peaks in preimages acquired at a plurality of positions.

Alternatively, it is also possible to identify the type of the vessel 1 on the basis of only the distance between peaks. Whether the culture surface 1a is rectangular or circular can be identified on the basis of the distance between peaks in a plurality of preimages, and, if the culture surface 1a is circular, the curvature and the diameter of the culture surface 1a can also be identified. Because the shape and the size of the culture surface 1a differ depending on the type of the vessel 1, it is possible to identify the type of the vessel 1 on the basis of only the distance between peaks in a plurality of preimages.

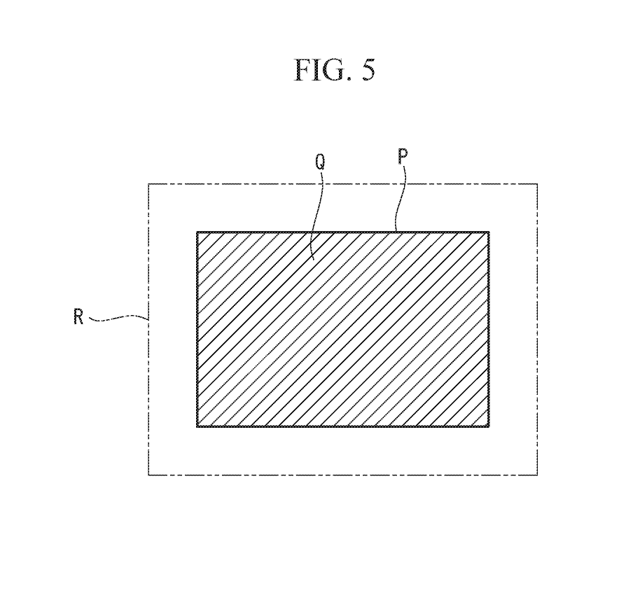

In this embodiment, although the image acquisition unit 2 acquires the vessel-region image P of only the region Q of the culture surface 1a, instead of this, as shown in FIG. 7, it is also possible to acquire images P′ of only rectangular ranges that include the regions Q of the culture surfaces 1a in the scanning direction of the line sensor 21.

In this case, because regions other than the regions Q are also included in the images P′, processing of excluding the regions other than the regions of the culture surfaces 1a from the images P′ is performed prior to the measurement of the state of the cells A, which is performed by the cell-state measurement unit 4. The images P′ are displayed on the display unit 6 together with measurement values.

In this way, when the image acquisition unit 2 acquires images P′ that include regions other than the regions Q, the image storage unit 5 may store the images P′ as they are; however, it is preferred that only the regions Q of the culture surfaces 1a be extracted from the images P′ to generate vessel-region images P, and the vessel-region images P be stored. In this case, instead of the images P′, the vessel-region images P are displayed on the display unit 6 together with the measurement values.

The image storage unit 5 may store the respective vessel-region images P in association with identification names.

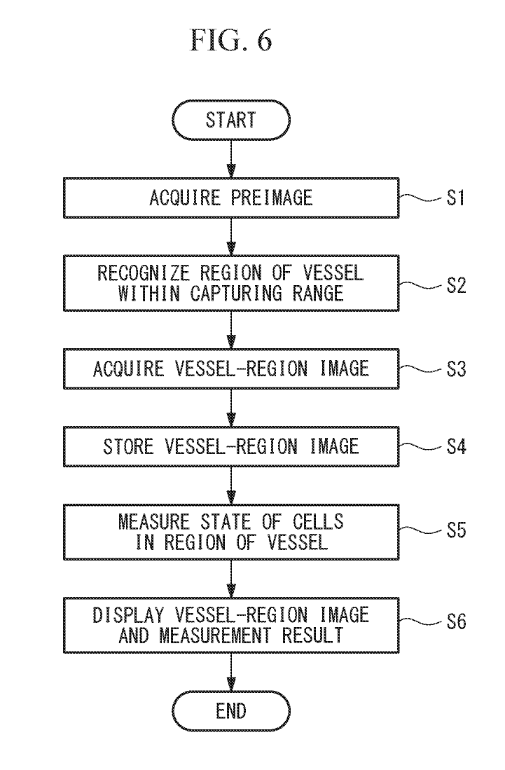

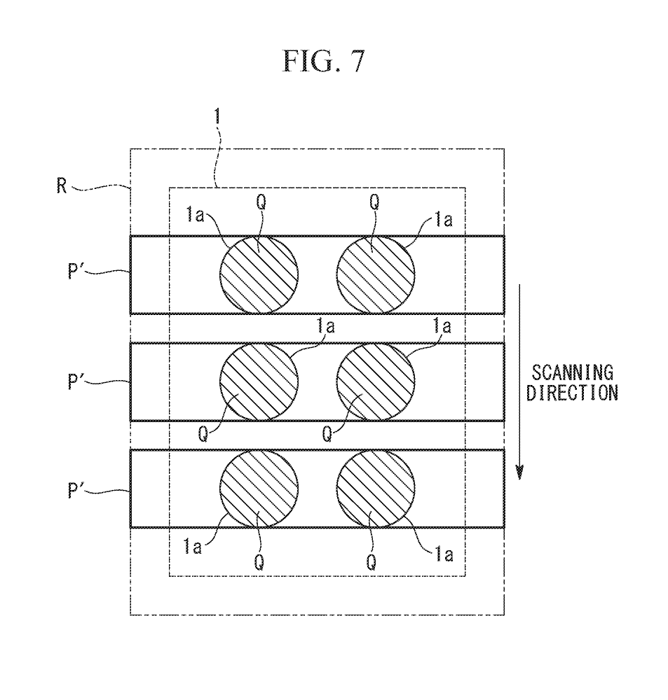

As shown in FIG. 8, in a case in which a multiwell plate 11 having a plurality of wells is placed on the stage 7a, and a plurality of the culture surfaces 1a are simultaneously captured, the plurality of the culture surfaces 1a are included in the capturing range R, as shown in FIGS. 4B and 4C. Therefore, a plurality of regions Q are recognized at a time by the vessel-region recognition unit 3, and a plurality of vessel-region images P are stored at a time in the image storage unit 5, as shown in FIG. 9.

By assigning identification names to the respective vessel-region images P, the operator can easily identify the images of the culture surfaces 1a corresponding to the vessel-region images P. It is preferred that the identification names be related to the culture surfaces 1a so as to easily identify the culture surfaces 1a. For example, addresses A-1, A-2, B-1, B-2, C-1, and C-2 indicating the positions of the respective wells in the multiwell plate 11 are used as the identification names. It is also possible for the operator to set an arbitrary character string in an identification name. Alternatively, the image storage unit 5 may automatically set an identification name on the basis of the type of the vessel 1 identified by the vessel-region recognition unit 3. For example, in a case in which the vessel 1 is the multiwell plate 11, the addresses of the wells may be automatically set in the identification names.

When a plurality of regions Q are included in the capturing range R, the cell-state measurement unit 4 measures the state of cells A in each of the plurality of regions Q, thus obtaining a plurality of measurement values. Specifically, the states of cells A in the plurality of wells can be accurately measured through only one image capturing.

When the multiwell plate 11 is used, different culture conditions are set for the respective culture surfaces 1a, in some cases. In such cases, the state of cells A can be compared between a plurality of wells or a plurality of vessels, on the basis of the measurement values of the plurality of the culture surfaces 1a.

Furthermore, the image storage unit 5 may select and store only the vessel-region image P of the region Q of the culture surface 1a where cells exist.

Among the plurality of wells in the multiwell plate 11, only some wells are used for culturing, in some cases. In such cases, the vessel-region images P of regions Q that do not include cells A are acquired. The vessel-region images P of the regions Q that do not include cells A are not stored, and the vessel-region images P of regions Q that include cells A are selectively stored, thereby making it possible to store only images P useful for the operator.

To make a determination whether cells A are included in a region Q, for example, measurement values at different times are used. The measurement values at different times are compared, and, if the measurement values are small and hardly change with time, it is determined that the measurement values are based on noise, and cells A are not included in the region Q.

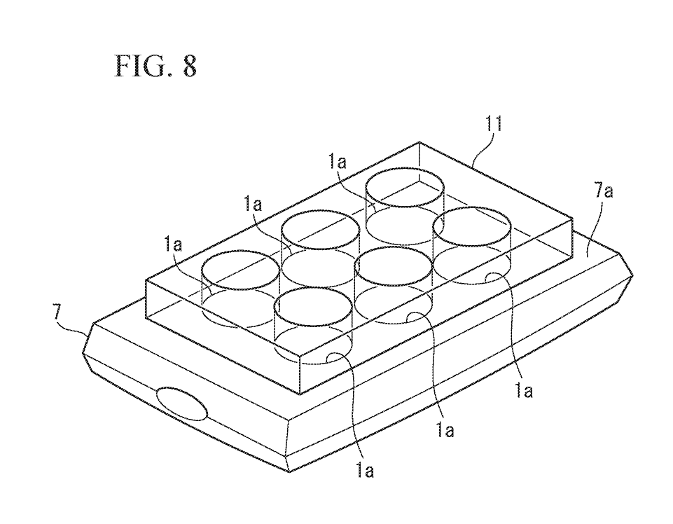

In this embodiment, as shown in FIG. 10, the image acquisition unit 2 may acquire a plurality of time-series vessel-region images P at predetermined time intervals.

In this case, the cell-state measurement unit 4 measures the state of cells A in each of the vessel-region images P. Accordingly, it is possible to obtain time-series measurement values for the same region Q.

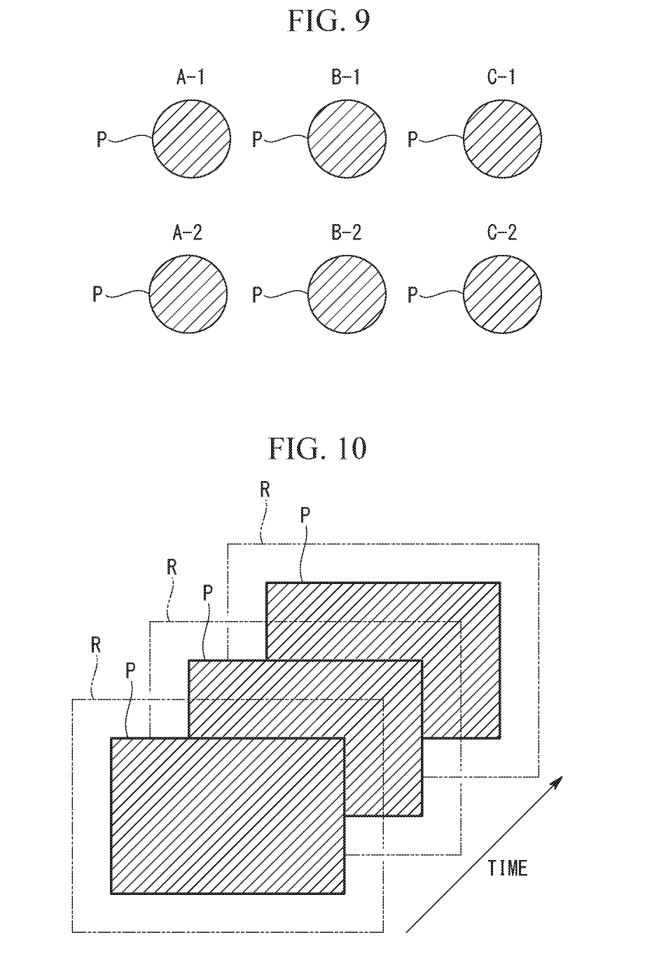

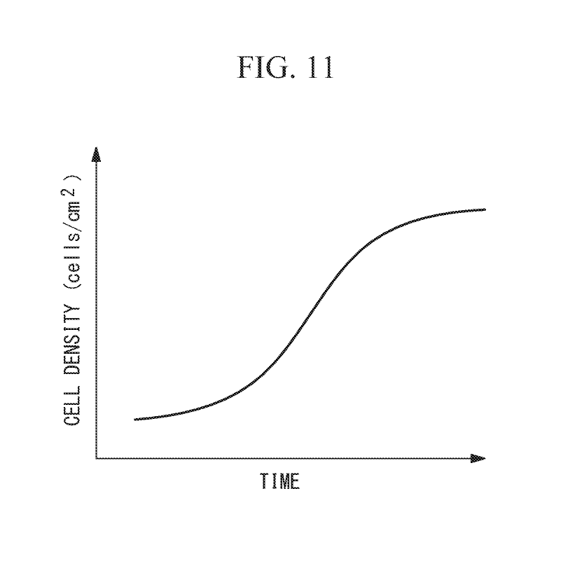

As shown in FIG. 11, the cell-state measurement unit 4 generates a graph expressing a temporal change of the measurement value. FIG. 11 shows an example case in which the cell density is measured as the state of cells A. As shown in FIG. 12, the graph is displayed on the display unit 6 side by side with the vessel-region image P or the image P′. In FIG. 12, a moving image of the time-series vessel-region images P is played. The vessel-region image P or the image P′ to be displayed on the display unit 6 may be subjected to image processing of coloring a region where cells A exist and a region where cells A do not exist, in different colors.

By doing so, the operator can easily grasp the temporal change of the state of the cells A cultured on the culture surface 1a, on the basis of the graph displayed on the display unit 6.

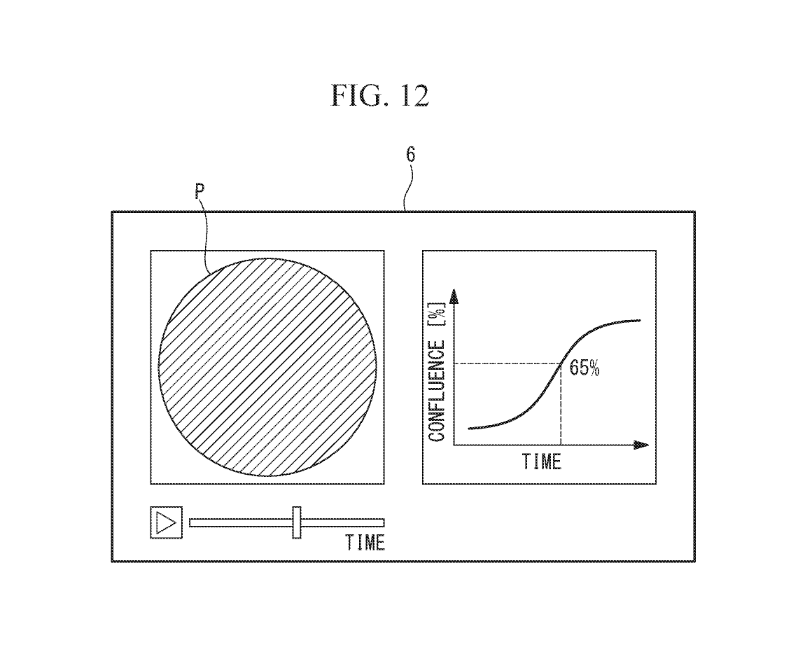

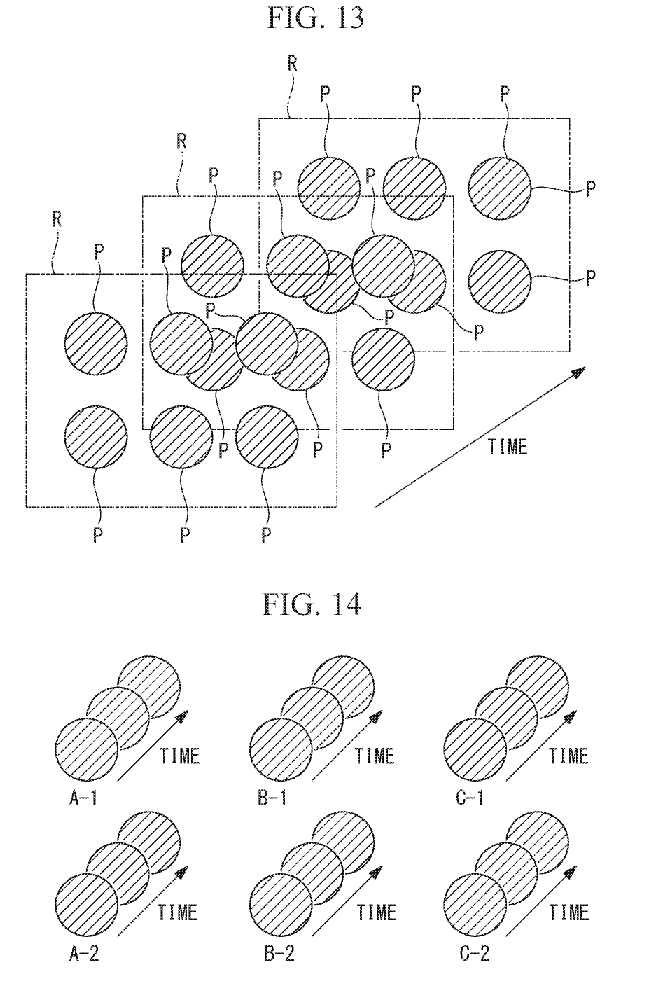

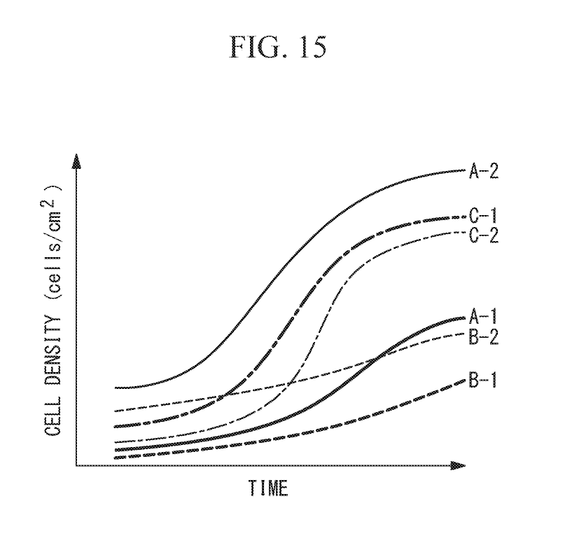

FIG. 13 shows an example case in which the multiwell plate 11 is used. In a case in which a plurality of regions Q of the culture surfaces 1a are included in the capturing range R, as shown in FIG. 14, time-series measurement values are obtained for the same region Q, and a graph is generated therefor. A plurality of generated graphs may be displayed on the display unit 6 in such a manner as to be overlapped with each other, as shown in FIG. 15.

In this embodiment, the cell-state measurement unit 4 may be able to change a measurement parameter used to measure the state of cells A.

The optimum measurement parameter differs depending on the type of cells A to be measured, the culture conditions, etc. Therefore, an appropriate measurement parameter for the measurement target is used, thereby making it possible to improve the accuracy of measurement of the state of cells A.

In a case in which a plurality of regions Q of the culture surfaces 1a are included within the capturing range R, measurement parameters may be set for the respective regions Q. For example, when different types of cells A are cultured in a plurality of wells, measurement parameters set for the respective cell types are used. By doing so, the accuracy of measurement of the state of cells A can be improved.

In this embodiment, in a case in which a plurality of regions Q of the culture surfaces 1a are included within the capturing range R, the cell-state measurement unit 4 may group a plurality of obtained measurement values and may integrate measurement values that belong to the same group, thus calculating a measurement value for each group.

For example, the measurement values are grouped by the type of cells A or by the culture condition. The condition for grouping may be set by the operator via an input means (not shown). The cell-state measurement unit 4 calculates the average value and the standard deviation of measurement values that belong to the same group and graphs the calculated average value and standard deviation of each group. The generated graph is displayed on the display unit 6.

In order to ensure the number of samples, the same type of cells A are cultured on a plurality of the culture surfaces 1a under the same culture condition, in some cases. The measurement values of such plurality of the culture surfaces 1a are treated as those in the same group, and the measurement values in the same group are integrated, thereby making it possible to provide data of a measurement value that is more valuable for the operator.

In this embodiment, although the number of cells and the cell density are mentioned as examples of the state of cells A, it is also possible to measure another index used for evaluation of the state of cells A. For example, in a case of cells that form a colony, the size of the colony, the number of colonies, or the density of colonies may be measured.

In this embodiment, although the illumination unit 23 is provided inside the housing 7, instead of this, it is also possible to provide an illumination unit outside the housing 7. For example, an illumination unit that is a separate body from the housing 7 may be provided above the vessel in the incubator. Alternatively, an illumination unit may be provided on a side plate or the top plate of the vessel 1.

In this embodiment, although light from cells detected by the line sensor 21 is light due to illumination light from the illumination unit, instead of this, light from cells may be fluorescence produced in the cells or light due to a luminous phenomenon.

The above-described embodiment also leads to the following invention.

In order to achieve the above-described object, the present invention provides the following solutions.

According to one aspect, the present invention provides a cell-state measurement device including: an image acquisition unit that has a straight line sensor for detecting light from cells cultured on a culture surface in a vessel, that acquires a preimage for one line in a longitudinal direction of the line sensor in a state in which the line sensor is immobilized, and that then acquires a 2D image within a predetermined capturing range by moving the line sensor in a scanning direction intersecting the longitudinal direction; a vessel-region recognition unit that recognizes the region of the culture surface within the capturing range on the basis of brightness changes in the preimage in the longitudinal direction of the line sensor; and a cell-state measurement unit that measures, within the 2D image, the state of the cells in the region of the culture surface recognized by the vessel-region recognition unit, wherein the image acquisition unit acquires, within the capturing range, the 2D image of only a range that includes, in the scanning direction, the region of the culture surface recognized by the vessel-region recognition unit.

According to this aspect, in the image acquisition unit, the line sensor is moved in the scanning direction with respect to the culture surface while detecting light from cells cultured on the culture surface, thereby acquiring a 2D image that includes the entire culture surface disposed within the capturing range. In this way, by using the image acquisition unit of the line-scan type, it is possible to acquire a wide range image in a short period of time, compared with a case in which many images are acquired by using a 2D image sensor.

In this case, prior to acquisition of the 2D image, the image acquisition unit acquires a preimage, i.e., information about the brightness for one line. Because brightness peaks appear in this preimage at the positions of the edges of the culture surface, the vessel-region recognition unit can recognize the region of the culture surface on the basis of brightness changes in the preimage. Then, the 2D image is acquired so as to include the region of the culture surface, and the cell-state measurement unit measures, within the 2D image, the state of cells in the region of the culture surface, which is recognized by the vessel-region recognition unit. Therefore, even if a region other than the region of the culture surface is included in the image capturing range of the image acquisition unit, only the region of the culture surface, where the cells are distributed, is selected as a measurement region. Accordingly, the state of the cells can be accurately measured. Furthermore, the 2D image, from which a region that does not include the culture surface in the scanning direction of the line sensor is excluded, is acquired. Accordingly, the data size of the 2D image can be reduced.

In the above-described aspect, the image acquisition unit may acquire, within the capturing range, the 2D image of only the region of the culture surface recognized by the vessel-region recognition unit.

By doing so, the data size of the 2D image can be further reduced.

In the above-described aspect, the vessel-region recognition unit may hold vessel information in which position information about the culture surface within the capturing range and information about the brightness changes in the preimage are associated with each other for each vessel type, and may recognize the region of the culture surface on the basis of the vessel information.

The types of vessels that are generally used for cell culturing are limited. The vessel-region recognition unit holds position information about a culture surface and information about brightness changes in a preimage in association with each other, for each vessel type, and compares the brightness changes in the preimage, which is acquired by the image acquisition unit, with brightness changes included in the vessel information, thereby making it possible to identify the type of a vessel in use and the position of the culture surface within the capturing range. Accordingly, the region of the culture surface can be recognized with high accuracy.

In the above-described aspect, the vessel-region recognition unit may recognize the region of the culture surface on the basis of: a brightness profile in the preimage; the number of brightness peaks in the preimage; or the distance between brightness peaks in the preimage.

By doing so, the region of the culture surface can be recognized with higher accuracy.

The above-described aspect may further include a stage on which the vessel is placed at a predetermined position, wherein the image acquisition unit may acquire the preimage at a predetermined image-acquisition position in the scanning direction.

By doing so, it is possible to acquire a preimage having substantially the same brightness changes for each vessel type. Therefore, the type of the vessel and the position of the culture surface can be identified with higher accuracy on the basis of the brightness changes in the preimage.

In the above-described aspect, the image acquisition unit may acquire the preimage at a plurality of positions located at intervals in the scanning direction.

By doing so, the region of the culture surface can be recognized with higher accuracy.

The above-described aspect may further include an image storage unit that stores a vessel-region image that is the 2D image of only the region of the culture surface recognized by the vessel-region recognition unit.

By doing so, it is possible to store and display a vessel-region image that includes only the region of the culture surface and that is valuable for an operator.

In the above-described aspect, the image storage unit may store an identification name in association with the vessel-region image.

In a case in which a multiwell plate or a plurality of vessels are used to acquire an image including a plurality of culture surfaces, a plurality of vessel-region images are generated from one image. In such a case, an identification name is associated with each of the vessel-region images, thereby making it possible for the operator to easily identify the image of the culture surface corresponding to the vessel-region image.

In the above-described aspect, the image storage unit may set the identification name to be associated with the vessel-region image, on the basis of the type of the vessel.

By doing so, an appropriate identification name for the type of the vessel can be automatically associated with the vessel-region image.

In the above-described aspect, the image storage unit may selectively store a vessel-region image of a culture surface where cells exist, on the basis of a measurement value obtained by the cell-state measurement unit.

By doing so, it is possible to store only an image valuable for the operator.

The above-described aspect may further include a display unit that displays an image acquired by the image acquisition unit.

In the above-described aspect, the display unit may display a vessel-region image that is the 2D image of only the region of the culture surface and a measurement value of the state of the cells.

By doing so, it is possible to provide the operator a display that facilitates comparison between the image of cells on the culture surface and the measurement value.

In the above-described aspect, the image acquisition unit may acquire a plurality of time-series 2D images at time intervals; and the display unit may display a temporal change of measurement values of the states of the cells, measured in the plurality of time-series 2D images.

By doing so, it is possible to easily grasp a temporal change in the state of cells on the basis of the displayed temporal change in the measurement values.

In the above-described aspect, the cell-state measurement unit may be able to change a measurement parameter used to measure the state of the cells, for each region of the culture surface.

By doing so, an appropriate measurement parameter is used for each culture surface according to the type of cells cultured on the culture surface or the culture condition, thereby making it possible to improve the measurement accuracy of the state of the cells.

In the above-described aspect, the cell-state measurement unit may group a plurality of measurement values measured in a plurality of regions of the culture surfaces, may integrate the measurement values that belong to the same group, may calculate the average value and the standard deviation of the measurement values in each group, and may graph the calculated average value and standard deviation.

By doing so, a plurality of measurement values are grouped by the type of cells or the culture condition, for example, and the average value and the standard deviation of the measurement values in each group are graphed, thereby making it possible to provide the operator data suitable for analysis of the measurement values in each group and for comparison of measurement values between groups.

### REFERENCE SIGNS LIST

100 cell-state measurement device
1 vessel
1a culture surface
2 image acquisition unit
21 line sensor
22 objective lens
23 illumination unit
24 scanning mechanism
3 vessel-region recognition unit
4 cell-state measurement unit
5 image storage unit
display unit
7 housing
8, 9 transmission and reception unit
10 vessel-type information acquisition unit
P vessel-region image
Q region of culture surface
R capturing range

1. A cell-state measurement device that acquires an image of a culture surface in a vessel formed of an optically transparent material and that measures a state of cells that are being cultured on the culture surface, the device comprising:
a housing that includes a stage on which the vessel is placed, the stage being formed of a horizontally disposed flat-plate-like member; and
an image acquisition unit that is accommodated in the housing and that is configured to acquire an image of the cells in the vessel,
wherein the image acquisition unit includes:
a line sensor that includes a plurality of light receiving elements which are linearly arranged;
an objective lens that is disposed between the line sensor and the stage;
an illuminator that illuminates a field of view of the objective lens; and
a scanner that moves the line sensor,
wherein the illuminator emits illumination light upward from a lower part of the vessel, and
wherein the illumination light emitted by the illuminator is reflected downward by a reflecting surface of a top plate of the vessel, is transmitted through the culture surface and is incident on the objective lens.

2. The cell-state measurement device according to claim 1,
wherein the scanner integrally moves the line sensor, the objective lens, and the illuminator in a direction perpendicular to a longitudinal direction of the line sensor.

3. The cell-state measurement device according to claim 1, further comprising transceivers that are respectively provided inside and outside the housing.

4. The cell-state measurement device according to claim 1, further comprising a computer including at least one processor, the at least one processor being configured to:
recognize a region of the culture surface in the vessel; and
measure a state of the cells in the recognized region,
wherein the at least one processor is configured to recognize the region of the culture surface on the basis of brightness changes in a preimage for one line in a longitudinal direction of the line sensor, the preimage being acquired by the image acquisition unit,
wherein the image acquisition unit is configured to acquire, after acquiring the preimage, a 2D image of only the recognized region, and
wherein the at least one processor is configured to measure the state of the cells by using the 2D image acquired by the image acquisition unit.

5. The cell-state measurement device according to claim 4, wherein the computer further includes a memory configured to hold vessel information in which position information about the culture surface and information about the brightness changes in the preimage are associated with each other for each vessel type, and
wherein the at least one processor is configured to recognize the region on the basis of the vessel information.

6. The cell-state measurement device according to claim 4, wherein the at least one processor is configured to recognize the region on the basis of a brightness profile in the preimage.

7. The cell-state measurement device according to claim 4, wherein the at least one processor is configured to recognize the region on the basis of the number of brightness peaks in the preimage.

8. The cell-state measurement device according to claim 4, wherein the at least one processor is configured to recognize the region on the basis of the distance between brightness peaks in the preimage.

9. The cell-state measurement device according to claim 4,
wherein the image acquisition unit is configured to acquire the preimage at a predetermined image-acquisition position.

10. The cell-state measurement device according to claim 4, wherein the image acquisition unit is configured to acquire the preimage at a plurality of positions located at intervals in a scanning direction.

11. The cell-state measurement device according to claim 4, further comprising a storage that stores a vessel-region image that is the 2D image of only the recognized region.

12. The cell-state measurement device according to claim 11, wherein the storage stores an identification name in association with the vessel-region image.

13. The cell-state measurement device according to claim 12, wherein the storage sets the identification name to be associated with the vessel-region image, on the basis of a type of the vessel.

14. The cell-state measurement device according to claim 11, wherein the storage selectively stores a vessel-region image of a culture surface where cells exist, on the basis of a measurement value obtained by the at least one processor.

15. The cell-state measurement device according to claim 1, further comprising a display that displays an image acquired by the image acquisition unit.

16. The cell-state measurement device according to claim 15, wherein the display displays a vessel-region image that is the 2D image of only the region of the culture surface and a measurement value of the state of the cells.

17. The cell-state measurement device according to claim 15,
wherein the image acquisition unit is configured to acquire a plurality of the 2D images at time intervals; and
the display displays a temporal change of measurement values of the states of the cells.

18. The cell-state measurement device according to claim 4, wherein the at least one processor is configured to change a measurement parameter used to measure the state of the cells, for each region of the culture surface.

19. The cell-state measurement device according to claim 4, wherein the at least one processor is configured to group a plurality of measurement values measured in a plurality of regions of the culture surfaces, integrate the measurement values that belong to the same group, calculate the average value and the standard deviation of the measurement values in each group, and graph the calculated average value and standard deviation.
